(19) United States
(12) Patent Application Publication
(10) Pub. No.: US 2008/0133826 A1
(43) Pub. Date: Jun. 5, 2008

(54) INFORMATION PROCESSING APPARATUS AND POWER SUPPLY CONTROL METHOD FOR INFORMATION PROCESSING APPARATUS

(75) Inventor: Takaaki Shimizu, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/947,407

(22) Filed: Nov. 29, 2007

(30) Foreign Application Priority Data
Nov. 30, 2006 (JP) 2006-324475

(51) Int. Cl. G06F 12/00

(52) U.S. Cl. 711/105; 711/E12.001

(57) ABSTRACT

According to one embodiment, there is provided an information processing apparatus including a power supply unit which outputs a voltage when an external AC current is supplied to the power supply unit, a nonvolatile memory, a volatile memory, and a control unit to which the nonvolatile memory and the volatile memory are connected and which performs control to transfer a program from the nonvolatile memory to the volatile memory when the voltage is supplied from the power supply unit to the control unit.

### CROSS-REFERENCE TO RELATED APPLICATIONS

This application is based upon and claims the benefit of priority from Japanese Patent Application No. 2006-324475, filed Nov. 30, 2006, the entire contents of which are incorporated herein by reference.

### BACKGROUND

1. Field

One embodiment of the present invention relates to a power supply to an information processing apparatus and a power supply control method for an information processing apparatus.

2. Description of the Related Art

In recent years, various information processing apparatuses have been developed and popularized. A large number of additional functions of the information processing apparatuses are desired. In particular, in a power supply unit of an information processing apparatus, a device to start an OS (Operation System) program at a high speed is desired.

In Patent Document 1 (Jpn. Pat. Appln. KOKAI Publication No. 2006-79468), the moment a standby mode is set, the contents are also recorded on an HDD (Hard Disc Driver). In this manner, when an AC power is continuously supplied during the standby mode, the program can be started at a high speed by using the contents in the memory. In this disclosure, when the AC power is interrupted, the contents in the HDD are copied, and the program can be started at a high speed by the using the contents.

However, in the conventional art in Patent Document 1, only a model equipped with an HDD can be devised in this way. In particular, after the product is purchased, when an AC power supply is connected to the main body, the program is not stored in a nonvolatile memory having a high processing speed. For this reason, high-speed start-up cannot be performed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an example of a basic configuration of an information processing apparatus according to an embodiment of the present invention;

FIG. 2 is a flow chart showing an example of a basic operation in a power-ON state of the information processing apparatus according to the embodiment of the present invention;

FIG. 3 is a block diagram showing an example of a configuration of the information processing apparatus according to the embodiment of the present invention;

FIG. 4 is a flow chart showing an example of an operation of a microcomputer unit (first control unit) in a power-ON state of the information processing apparatus according to the embodiment of the present invention;

FIG. 5 is a flow chart showing an example of an operation of a CPU unit (second control unit) in a power-ON state of the information processing apparatus according to the embodiment of the present invention;

FIG. 6 is a timing chart showing an example in a power-ON state of the information processing apparatus according to the embodiment of the present invention; and

FIG. 7 is a block diagram showing an example of a configuration of a receiving apparatus serving as the information processing apparatus according to the embodiment of the present invention.

### DETAILED DESCRIPTION

Various embodiments according to the invention will be described hereinafter with reference to the accompanying drawings. In general, according to one embodiment of the invention, an information processing apparatus comprising: a power supply unit which outputs a voltage when an external AC current is supplied to the power supply unit; a nonvolatile memory; a volatile memory; and a control unit to which the nonvolatile memory and the volatile memory are connected and which performs control to transfer a program from the nonvolatile memory to the volatile memory when the voltage is supplied from the power supply unit to the control unit.

An embodiment of the present invention will be described below in detail with reference to the accompanying drawings.

<Information Processing Apparatus According to One Embodiment of the Present Invention>

(Basic Configuration and Operation)

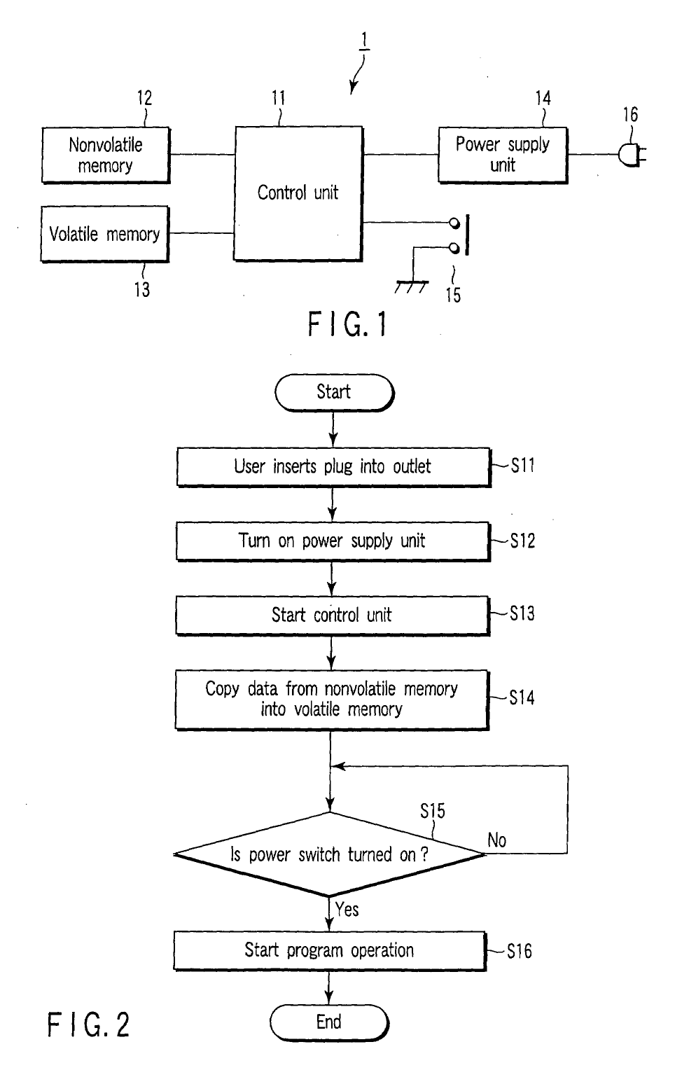

FIG. 1 is a block diagram showing an example of a basic configuration of an information processing apparatus according to an embodiment of the present invention. FIG. 2 is a flow chart showing an example of a basic operation in a power-ON state of the information processing apparatus according to the embodiment of the present invention. Steps in the flow charts in FIGS. 2, 4, and 5 can be replaced with circuit blocks, respectively. Therefore, all the steps in the flow charts can be redefined as the blocks, respectively.

An information processing apparatus 1 according to an embodiment of the present invention serves as a basic configuration. As shown in FIG. 1, the information processing apparatus 1 has a control unit 11, a nonvolatile memory 12 such as a flash memory or an HDD (Hard Disk Driver) connected to the control unit 11, and a volatile memory 13 such as a DRAM (Dynamic Random Access Memory) connected to the control unit 11. Furthermore, the information processing apparatus 1 has a power switch 15 connected to the control unit 11, a main power supply 14 for supplying a power to the control unit 11, and an AC plug 16 connected to the main power supply 14.

The information processing apparatus 1 having the above configuration performs the following operation immediately after the apparatus is purchased. More specifically, as shown in the flow chart in FIG. 2, first, a user connects the AC plug 16 to an AC outlet (not shown) (step S11). In this manner, an AC voltage is applied to the main power supply 14 to turn on the main power supply 14 (step S12). The main power supply 14 converts the AC voltage into a DC power as an example and supplies the DC current to the control unit 11 to start the control unit 11 (step S13).

The control unit 11 reads a start program such as a boot program BIOS together with data stored in the nonvolatile memory 12. According to the start program, a program such as an OS (Operation System) is read from the nonvolatile memory 12 and copied and developed into the volatile memory 13 having a high processing speed (step S14).

Thereafter, when a user depresses the power switch 15 or the like, a program such as the OS (Operation System) stored in the volatile memory 13 having a high processing speed is operated. In this manner, the user connects the AC plug of the information processing apparatus and, thereafter depresses the power switch 15 to make it possible to start a program such as an OS at a high speed.

(Configuration of One Embodiment)

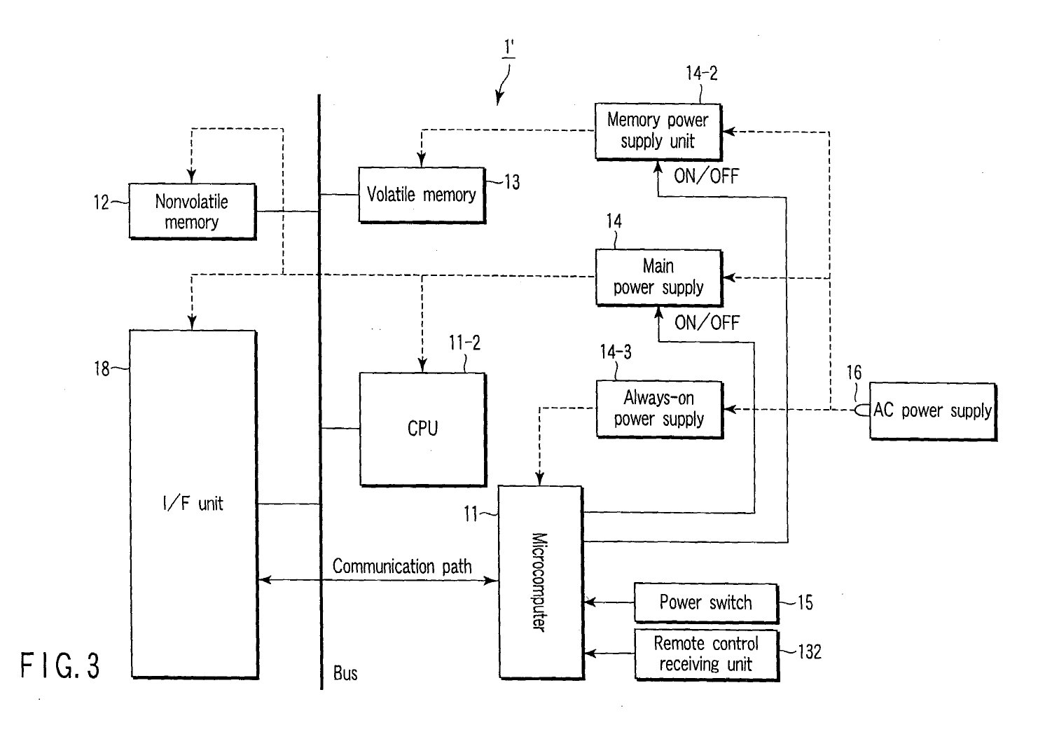

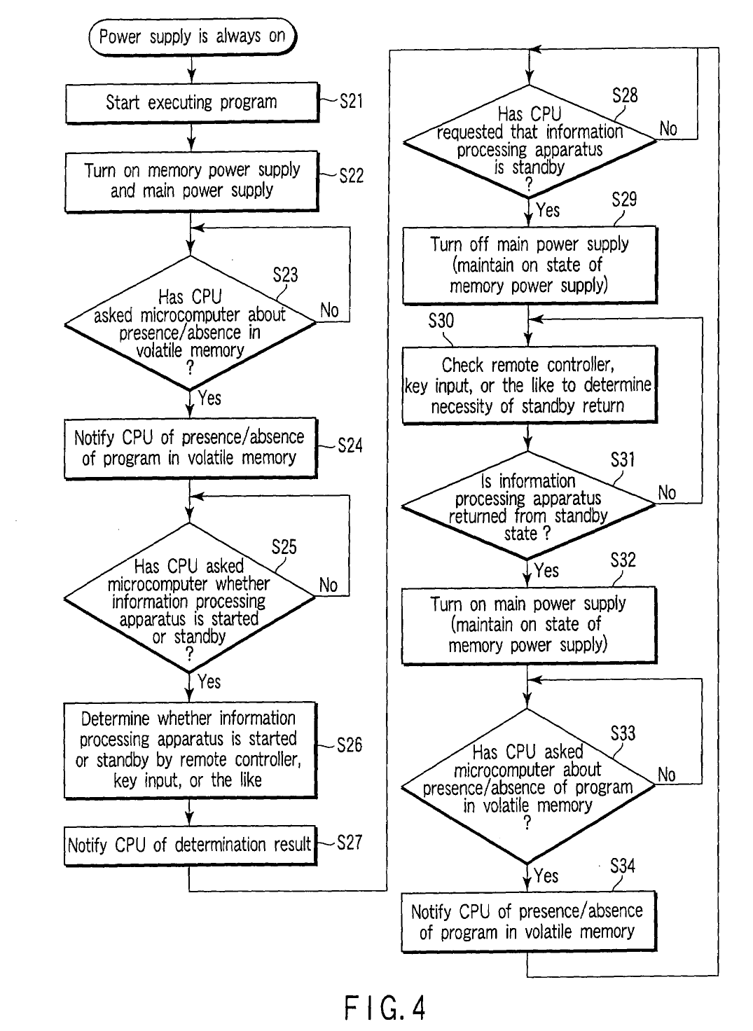

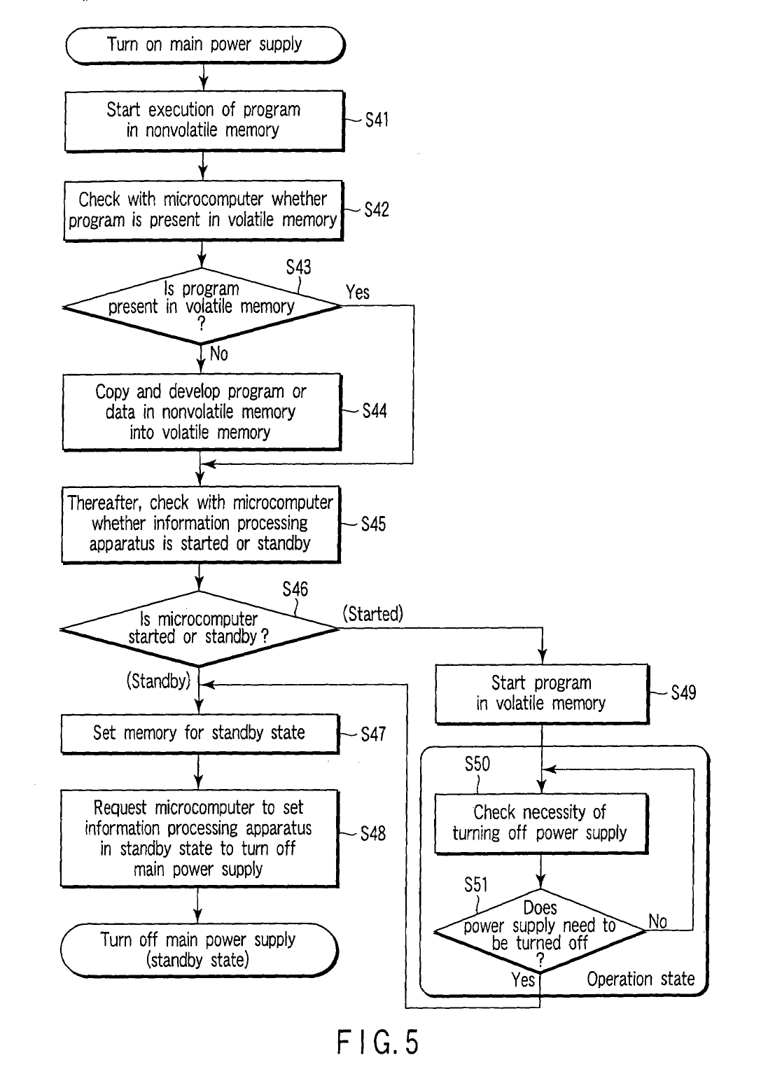

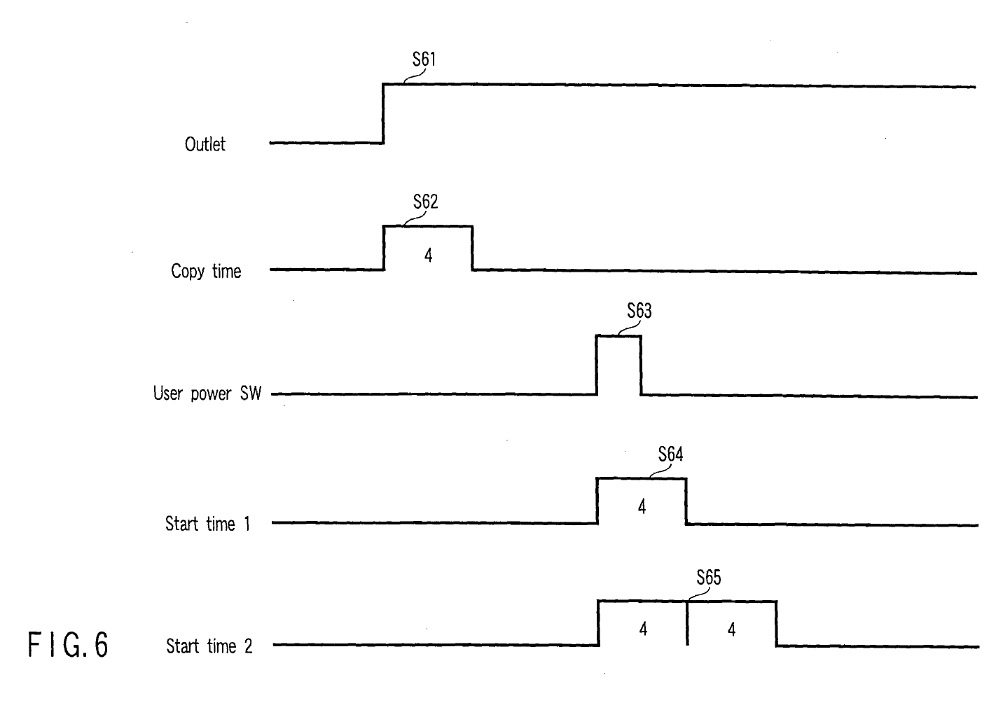

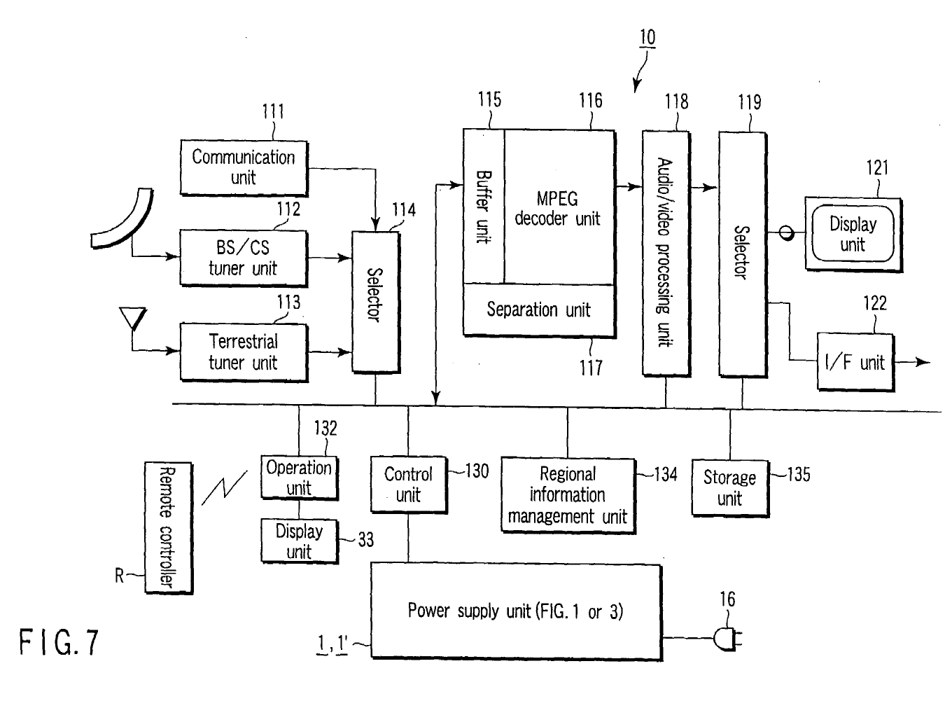

A more detailed information processing apparatus according to the embodiment of the present invention will be described below with reference to the accompanying drawings. FIG. 3 is a block diagram showing an example of a configuration of the information processing apparatus according to the embodiment of the present invention. FIG. 4 is a flow chart showing an example of an operation of a microcomputer unit (first control unit) in a power-ON state of the information processing apparatus according to the embodiment of the present invention. FIG. 5 is a flow chart showing an example of an operation of a CPU (second control unit) in a power-ON state of the information processing apparatus according to the embodiment of the present invention. FIG. 6 is a timing chart showing an example in a power-ON state of the information processing apparatus according to the embodiment of the present invention.

An information processing apparatus 1′ according to the embodiment of the present invention, as shown in FIG. 3, has a microcomputer 11 serving as a first control unit, a CPU 11-2 serving as a second control unit, a nonvolatile memory 12 such as a flash memory or an HDD connected to the CPU 11-2, and the volatile memory 13 such as a DRAM (Dynamic Random Access Memory) connected to the CPU 11-2. The microcomputer 11 is always basically operated when an AC power supply is connected. However, the microcomputer 11 is preferably mounted such that a power-saving operation and a normal operation are switched by a timer or interruption.

The microcomputer 11 and the CPU 11-2 can exchange information through a peripheral such as a UART (Universal Asynchronous Receiver Transceiver) or an I/O port.

Furthermore, the information processing apparatus 1′ has the power switch 15 connected to the microcomputer 11, a remote control receiving unit 132, and an I/F unit 18 connected to the microcomputer 11 through a communication path to make it possible to receive an operation signal from a user.

In addition, the information processing apparatus 1′ has the main power supply 14 which is connected to the AC plug 16 insertable into an AC outlet and supplies power to the CPU 11-2, the nonvolatile memory 12 and the I/F unit 18, an always-on power supply unit 14-3 which always outputs power when the AC power supply is connected and to which the AC plug 16 insertable into an AC outlet is connected to supply power to the microcomputer 11, and a memory power supply unit 14-2 to which the AC plug 16 insertable into an AC outlet is connected to supply power to the volatile memory 13. A broken line in FIG. 3 means power supply from the power supply units to the units.

The power supply units 14, 14-2, and 14-3 are independent of each other in FIG. 3. However, depending on mounting states, the main power supply 14 and the memory power supply unit 14-2 can be constructed to be branched from the always-on power supply 14-3.

(Operation)

Terms

An operation of the information processing apparatus 1′ will be described below with reference to the flow charts in FIGS. 4 and 5. Several terms used here will be defined below first.

[Cold Start] This is a mode in which the information processing apparatus 1′ is started without using the program in the volatile memory 13 when the CPU 11-2 begins to operate. More specifically, the CPU 11-2 starts the programs from the program in the nonvolatile memory 12. Depending on cases, the program or data in the nonvolatile memory 12 is copied and developed into the volatile memory 13, and the information processing apparatus 1′ is operated by using the program or the data.

[Standby State] This is a mode in which the main power supply 14, which supplies power to the CPU 11-2, the volatile memory 13 and the I/F unit 18 such as various peripherals, is kept off to realize a power saving state having a power lower than that in an operation state, and the memory power supply unit 14-2, which supplies power to the volatile memory 13 and optionally to a memory controller (not shown), is kept on to hold the contents of the volatile memory 13.

For example, when a DDR SRAM is used as the nonvolatile memory 12, before shift to the standby state, an appropriate process such as transmission of a self-refreshing command to the nonvolatile memory 12 must be performed to hold the contents of the nonvolatile memory 12 before the standby state is set.

[Hot Start] This is a mode in which the information processing apparatus 1′ is started by using the data in the volatile memory 13 at a point of time when the CPU 11-2 begins to start. More specifically, the mode can be applied only when starting is performed from the standby state in which the data in the volatile memory 13 is held. Since the time taken to copy and develop the program and the data from the nonvolatile memory 12 to the volatile memory 13 is unnecessary, the information processing apparatus 1′ can be started at a higher speed than the cold start.

Operation Process

A start operation of the information processing apparatus 1′ will be described below with reference to the flow charts in FIGS. 4 and 5. In this case, by explaining the flow chart in FIG. 4 and the flow chart in FIG. 5 to specify the operations of the microcomputer 11 serving as the first control unit and the CPU 11-2 serving as the second control unit, the start operation for the information processing apparatus 1′ will be described below.

First, in the flow chart in FIG. 4, a user inserts the AC plug 16 into an AC outlet (not shown) to turn on the always-on power supply 14-3. In this manner, the microcomputer 11 executes a program to perform the operation shown in the flow chart in FIG. 4 (step S21). In this manner, the microcomputer 11 turns on the memory power supply unit 14-2 and the main power supply 14 (step S22).

It is determined whether the microcomputer 11 is asked by the CPU 11-2 about the presence of the program in the volatile memory 13 “that is, hot start or cold start” (step S23). When the microcomputer 11 is asked about this, the microcomputer 11 notifies the CPU 11-2 of the presence/absence of the program in the volatile memory through a communication path (step S24). When an I/O port is used, only an output from the microcomputer may be read.

It is then determined whether the microcomputer 11 is asked by the CPU 11-2 whether the information processing apparatus is started or put on standby (step S25). When the microcomputer 11 is asked about this, the microcomputer 11 determines that the information processing apparatus is started when data is input by a key on the remote controller R, the power switch 15, or the like, otherwise, the microcomputer 11 determines that the information processing apparatus is standby (step S26). The microcomputer 11 notifies the CPU 11-2 of the determination result (step S27).

Furthermore, the microcomputer 11 determines whether the CPU 11-2 requests that the information processing apparatus is standby (step S28). When it is requested that the information processing apparatus is standby, the microcomputer 11 turns on the main power supply 14, and the memory power supply unit 14-2 outputs a control signal to maintain an ON state (step S29).

Thereafter, the microcomputer 11 checks the key input of the remote controller R, the power switch 15, or the like to determine whether standby return is necessary (step S30). When the microcomputer 11 receives an operation signal generated by operation by a switch of the remote controller R to determine that the standby return is necessary (step S31), the main power supply 14 is turned on again (at this time, the memory power supply unit 14-2 is also kept in an ON state) (step S32).

Furthermore, it is determined whether the microcomputer 11 is asked by the CPU 11-2 about the presence/absence of the program in the volatile memory 13 (step S33). When the microcomputer 11 is asked about this, the microcomputer 11 notifies the CPU 11-2 of the presence/absence of the program in the volatile memory 13 (step S34). The microcomputer 11 repeats these operations until a power is supplied from the always-on power supply 14-3.

An operation of the CPU 11-2 serving as the second control unit will be described below with reference to the flow chart in FIG. 5. First, as described above, under the control of the microcomputer 11, when the main power supply 14 is turned on to supply power from the main power supply 14 to the CPU 11-2, the CPU 11-2 executes the program stored in, for example, the nonvolatile memory 12 to perform the operation shown in the flow chart in, for example, FIG. 5 (step S41).

In this manner, first, the CPU 11-2 asks the microcomputer 11 whether a program has been stored in the volatile memory 13 (step S42). When the microcomputer 11 notifies the CPU 11-2 that the program has not been stored in the volatile memory 13 (cold start) (step S43), the CPU 11-2 copies and develops a program or data such as an OS (Operation System) in the nonvolatile memory 12 into the volatile memory 13 (step S44). If, in step S43, the microcomputer 11 notifies the CPU 11-2 that the program has been stored in the volatile memory 13 (hot start), this step is not performed.

The CPU 11-2, thereafter, checks with the microcomputer 11 whether the information processing apparatus is started or standby (step S45). In contrast to this, when the microcomputer 11 designates the CPU 11-2 that the information processing apparatus is made standby (step S46), the CPU 11-2 sets the volatile memory 13 in standby states (step S47). More specifically, after the volatile memory 13 being in the standby states, the CPU 11-2 requests the microcomputer 11 to off the main power supply 14 through a communication path. Then, as described in step S9 in the flow chart in FIG. 4, the main power supply 14 is turned off by the microcomputer 11 (step S48). As a result, the information processing apparatus 1′ is set in a standby state to be standby.

In this case, the case using communication is exemplified. However, in use of an I/O port, when starting is necessary, the information processing apparatus is necessarily started, an I/O is set to mean the necessity. At this stage, the CPU may immediately shift to the next step.

In step S46, when the microcomputer 11 designates the CPU 11-2 to be started, the CPU 11-2 starts a program such as an OS stored in the volatile memory 13 (step S49). As a result, the information processing apparatus 1′ is set in an operation state by starting the OS or the like. The CPU 11-2 always continuously checks whether the power switch 15 or the power switch of the remote controller R is turned off, by means of detecting the state of the power switch 15 or the remote controller R through a communication path (step S50). The operation state is continued until the CPU 11-2 receives an operation signal to designate a power-off state, making it necessary to set the power-off state (step S51). Here, the power-off state means that a power of the CPU and the non-volatile memory (except for the microcomputer unit and the volatile memory) is off. When the information processing apparatus must be powered-off, the CPU 11-2 shifts to step S47 to set a standby state.

As described in detail, in the detailed embodiment using the plurality of control units 11 and 11-2 shown in FIG. 3, the microcomputer 11 controls power supply to the respective units to realize a standby state.

As described above, when the AC plug 16 is merely inserted into an AC outlet, as shown in step S44, the program in the nonvolatile memory 12 is copied and developed into the volatile memory 13. In this manner, thereafter, a user operates the power switch 15 or the like to make it possible to start the OS or the like immediately.

This manner will be described below with reference to the timing chart in FIG. 6. FIG. 6 is a timing chart showing an example in a power-on state of the information processing apparatus according to the embodiment of the present invention. More specifically, in the information processing apparatus 1′ according to the embodiment of the present invention, when the AC plug 16 is inserted into an AC outlet (not shown) (step S61), as described above, at this timing, a program such as an OS or data is copied from the nonvolatile memory 12 into the volatile memory 13. This time is temporarily set to be about 4 seconds (switch S62).

Thereafter, when a user depresses the power switch 15 or the like to power on the information processing apparatus (step S63), in the information processing apparatus 1′ according to the embodiment of the present invention, the program has already been copied in the volatile memory 13. For this reason, for only the time for which the OS or the like is started, in this case, after the power switch 15 is depressed, the system is temporarily started “about 4 seconds later” (step S64).

On the other hand, as in the information processing apparatus 1′ according to the embodiment of the present invention, when the automatic program copying process caused by turning on the AC power supply is not performed, after the power switch 15 is depressed and the program is copied in the volatile memory 13, the OS or the like is started. For this reason, it is assumed that the system is temporarily started “about 8 seconds later” (step S65). Therefore, by the automatic program copying process according to the embodiment of the present invention, start time can be shortened by about 4 seconds.

Furthermore, in another embodiment, as a power-saving mode, not only the standby mode, but also a perfect standby mode which turns off both the memory power supply unit 14-2 and the main power supply 14 is preferably used. Still furthermore, it is preferable to selectively perform simultaneous use of an active standby mode which keeps both the memory power supply unit 14-2 and the main power supply 14 on and the power-saving mode.

<Receiving Apparatus According to One Embodiment of the Present Invention>

As the information processing apparatus according to the embodiment, an example of a receiving apparatus such as a digital television set will be described below in detail with reference to FIG. 7. FIG. 7 is a block diagram showing an example of a configuration of a receiving apparatus serving as the information processing apparatus according to the embodiment of the present invention.

(Configuration and Operation of Receiving Apparatus)

A receiving apparatus 10 in FIG. 7 is a digital television apparatus. A control unit 130 is connected to units through data buses to control an entire operation of the apparatus.

The receiving apparatus 10 in FIG. 7 includes, as main constituent elements, an MPEG decoder unit 116 constituting a reproducing side and the control unit 130 for controlling an operation of the apparatus main body. The receiving apparatus 10 has a selector 114 on an input side and a selector 119 on an output side. A communication unit 111 having a LAN function and a mail function, a so-called satellite (BS/CS) tuner unit 112, and a so-called terrestrial tuner unit 113 are connected to the selector 114 on the input side. A satellite antenna is connected to the BS/CS tuner unit 112, and a terrestrial antenna is connected to the terrestrial tuner unit 113.

Furthermore, the receiving apparatus 10 has the MPEG decoder unit 116, a separation unit 117, a regional information management unit 134 (will be described later), and a storage unit 135 for storing regional information. These units are connected to the control unit 130 through the data buses. An output from the selector 119 is connected to a display unit 121 and supplied to an external apparatus through an interface unit 122 which communicates with the external apparatus.

Still furthermore, the receiving apparatus 10 is connected to the control unit 130 through the data bus, and has an operation unit 132 which is operated by a user or operated through the remote controller R. In this case, the remote controller R enables operations almost equivalent to those of the operation unit 132 arranged on the main body of the receiving apparatus 10. With the remote controller R, various settings such as an operation of the tuner can be performed.

In the receiving apparatus 10 serving as the digital television set, broadcast signals are input from a receiving antenna to the tuner units 112 and 113, and tuning is performed in the tuner units 112 and 113. A video/audio signal obtained by the tuning is decoded by the MPEG decoder unit 116 or the like and supplied to an audio/video processing unit 118.

In order to perform tuning and input switching, an operation signal from the remote controller R is supplied to the control unit 130 through the operation unit 132. As a result, the MPEG decoder unit 116 and the audio/video processing unit 118 are controlled. The video signal processed by the audio/video processing unit 118 is displayed on the display unit 121 through the selector 119. The audio signal is also supplied to a loudspeaker or the like (not shown).

In the receiving apparatus 10 serving as the information processing apparatus having the above configuration, as shown in FIG. 7, power supply units 1 and 1′ shown in FIG. 1 or 3 are preferably arranged. At this time, the control unit 130 corresponds to the control unit 11 in FIG. 1 or the control unit 11-2 in FIG. 3.

The receiving apparatus 10 has the power supply units 1 and 1′. Thus, as described above, when the AC plug is inserted into an outlet (not shown), thereafter, a program such as an OS can be started at a high speed by depressing the power switch of the operation unit 132.

According to the various embodiments described above, a person skilled in the art can realize the present invention. However, furthermore, a person skilled in the art can easily conceive various modifications of the embodiments, and can apply the present invention to various embodiments without inventive ability. Therefore, the present invention covers a wide range consistent with the disclosed principle and the novel characteristic features, and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a power supply unit which outputs a voltage when an external AC current is supplied to the power supply unit;
a nonvolatile memory;
a volatile memory; and
a control unit to which the nonvolatile memory and the volatile memory are connected and which performs control to transfer a program from the nonvolatile memory to the volatile memory when the voltage is supplied from the power supply unit to the control unit.

2. The information processing apparatus according to claim 1, wherein the control unit receives an operation signal to execute the program stored in the volatile memory.

3. The information processing apparatus according to claim 1, wherein the control unit performs information processing to given information by executing the program.

4. An information processing apparatus comprising:
a power supply unit which, when an external AC current is supplied to the power supply unit, converts the AC current to output a voltage to a first control unit and to a second control unit different from the first control unit;
a nonvolatile memory;
a volatile memory;
the first control unit which, when the voltage is supplied from the power supply unit, controls the power supply unit to supply a voltage to the nonvolatile memory, the volatile memory, and the second control unit; and
a second control unit to which the nonvolatile memory and the volatile memory are connected and which transfers a program from the nonvolatile memory to the volatile memory when a power is supplied from the power supply unit under the control of the first control unit.

5. The information processing apparatus according to claim 4, wherein the power supply unit is separated into a first power supply unit which supplies the voltage to the first control unit, a second power supply unit which supplies the voltage to the second control unit, and a third power supply unit which supplies the voltage to the volatile memory.

6. The information processing apparatus according to claim 4, wherein the second control unit executes the program stored in the volatile memory in response to an operation signal.

7. The information processing apparatus according to claim 4, wherein the first control unit performs control to interrupt supply of the voltage to the second control unit again.

8. The information processing apparatus according to claim 4, further comprising:
a tuner unit which is controlled by the second control unit and which demodulates a broadcast signal to output an audio/video signal;
a decoding unit which is controlled by the second control unit to decode the audio/video signal; and
a display unit which displays a video according to the decoded video signal.

9. A power supply control method for controlling a voltage of an information processing apparatus having a power supply unit, a nonvolatile memory, a volatile memory, and a control unit, the method comprising:
transferring a program stored in the nonvolatile memory to the volatile memory when a voltage is supplied from the power supply unit to the control unit.
